(19) United States
(12) Patent Application Publication
(10) Pub. No.: US 2006/0222823 A1
(43) Pub. Date: Oct. 5, 2006

(54) Hinged laminated plastic product and method of making

(76) Inventor: Jason P. Hiller, Chicago, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/393,337

(22) Filed: Mar. 30, 2006

Related U.S. Application Data
(60) Provisional application No. 60/667,385, filed on Apr. 1, 2005.

(51) Int. Cl. B32B 3/00

(52) U.S. Cl. 428/189

(57) ABSTRACT

A laminated folding product includes a plastic substrate layer having first and second opposed surfaces, a first transparent laminate layer covering the first surface of the substrate layer, and a second transparent laminate layer covering the second surface of the substrate layer. Indicia is printed on the substrate layer. Each laminate layer contains two laminate sheets, each covering a portion of one of the surfaces of the substrate. The substrate is made up of a plurality of panels arranged in a row and positioned in parallel and spaced relation to each other. The product folds along a plurality of hinges. A living hinge is defined by exposed portions of the substrate surfaces and extends across the product. A plurality of lateral hinges extend between the substrate panels, transverse to the living hinge.

### CROSS-REFERENCE TO RELATED APPLICATIONS

This application claims the benefit of U.S. Provisional Application Ser. No. 60/667,385, filed Apr. 1, 2005, which is incorporated by reference herein and made a part hereof.

### TECHNICAL FIELD

The present invention relates generally to laminated products, and more particularly to various embodiments and methods for laminating multiple plastic panels in a foldable format.

### BACKGROUND

Foldable laminated products are well known in the art. Such foldable laminated products are often used as maps, brochures, reference guides, and other similar products. While foldable laminated products according to the prior art provide a number of advantageous features, they nevertheless have certain limitations. The present invention seeks to overcome certain of these limitations and other drawbacks of the prior art, and to provide new features not heretofore available.

### SUMMARY OF THE INVENTION

A laminated folding product is disclosed, including a plastic substrate layer having first and second opposed surfaces, a first transparent laminate layer covering the first surface of the substrate layer, a second transparent laminate layer covering the second surface of the substrate layer, and a linear hinge extending across the product. Indicia is printed on the substrate layer.

According to one embodiment, the hinge is a living hinge defined by an exposed portion of the first surface of the substrate and an exposed portion of the second surface of the substrate.

According to another embodiment, a second linear hinge extends across the product transverse to the first linear hinge, and the product folds along the first linear hinge and the second linear hinge. The second linear hinge is defined by a portion of the first laminate layer, a portion of the second laminate layer, and an absence of the substrate layer.

According to another embodiment, the plastic substrate is made of polypropylene.

According to another embodiment, the substrate layer includes at least two rectangular panels extending across the width of the product, each having a top surface and a bottom surface. The panels are arranged in a single row and positioned in parallel and spaced relation to each other.

According to another embodiment, the first laminate layer includes two laminate sheets, each covering a portion of the first surface of the substrate, and the second laminate layer includes two laminate sheets, each covering a portion of the second surface of the substrate.

Other features and advantages of the invention will be apparent from the following examples in the specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of one embodiment of a hinged laminated product of the present invention in an unfolded state;

FIG. 2 is an exploded perspective view of the hinged laminated product of FIG. 1;

FIG. 3 is a perspective view of the hinged laminated product of FIG. 1 in a partially folded state;

FIG. 4 is a perspective view of the hinged laminated product of FIG. 1 in a folded state, with broken lines indicating the product in a partially-folded state and arrows indicating the folding of the product;

FIG. 5 is a schematic view of a machine and process used in manufacturing a hinged laminated product of the present invention;

FIG. 6 is a cross-sectional view of the hinged laminated product of FIG. 1, taken along lines 6-6 of FIG. 1;

FIG. 7 is a perspective view of another embodiment of a hinged laminated product of the present invention in an unfolded state;

FIG. 8 is a perspective view of a folder of the present invention in an unassembled state, with broken lines and arrows indicating the assembly of the folder;

FIG. 9 is a perspective view of the folder of FIG. 8 in a partially-assembled state and two folded hinged laminated products of the present invention, with arrows indicating insertion of the hinged laminated products into the folder; and

FIG. 10 is a perspective view of the folder of FIG. 8 in an assembled state and two folded hinged laminated products of the present invention inserted therein, with broken lines and arrows illustrating the folding of the folder.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

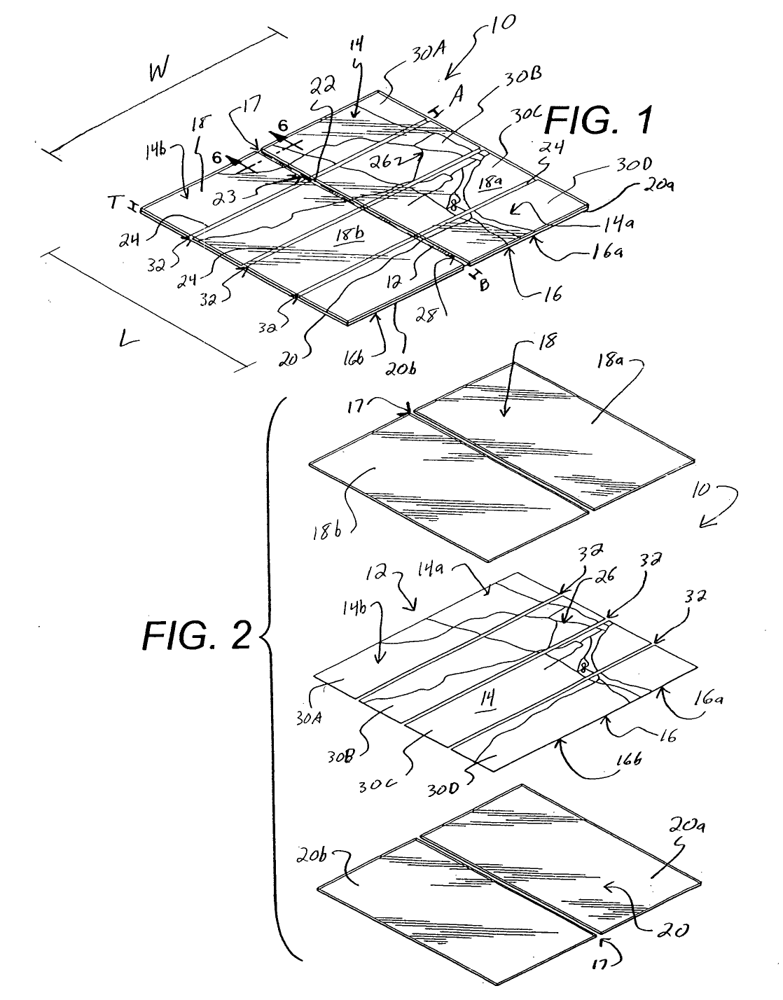

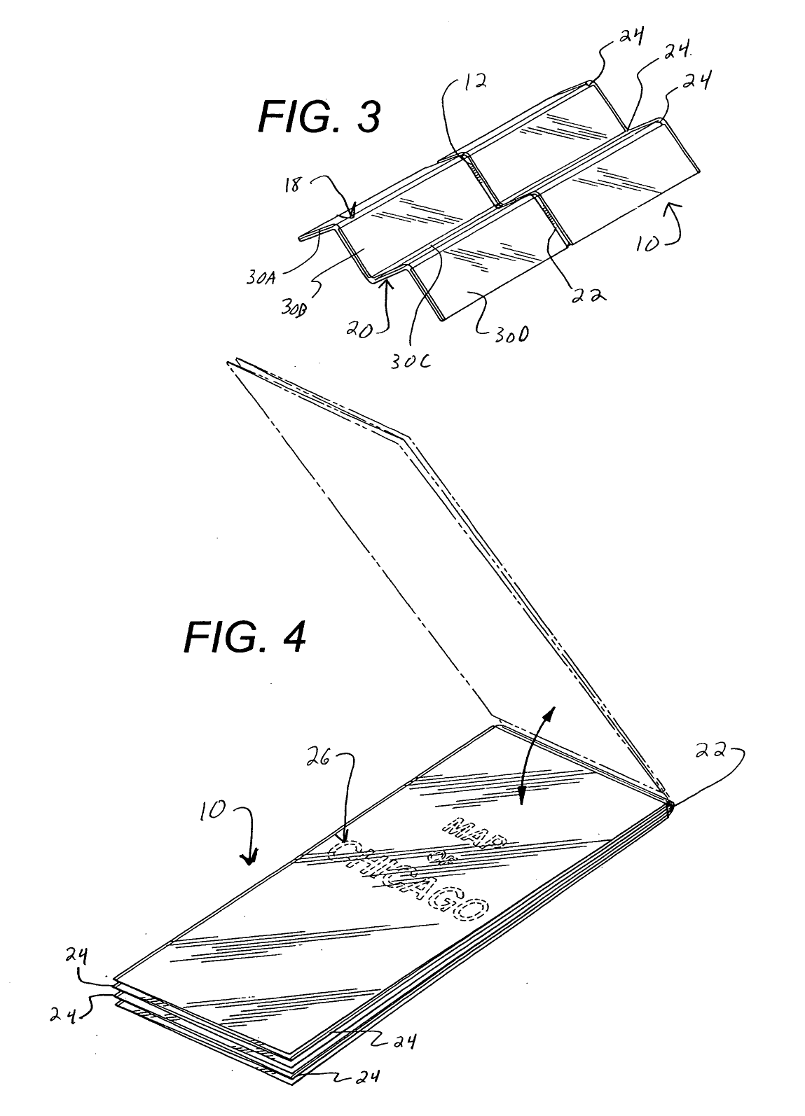

Referring now to the Figures, and initially to FIGS. 1, 2, and 6, there is shown a hinged laminated product 10. The hinged laminated product 10 generally includes a substrate layer 12 having first and second opposed surfaces 14,16, a first laminate layer 18 covering the first surface 14 of the substrate layer 12, a second laminate layer 20 covering the second surface 16 of the substrate layer 12, and one or more linear hinges 22,24 extending across the product 10. The product 10 is preferably a sheet, having a length L and a width W, which are significantly greater than a thickness T. In one embodiment, the length L is preferably greater than the width W. Additionally, the product 10 preferably folds along the hinges 22,24 to create a folded product 10 as shown in FIG. 4. The product 10 is shown in an unfolded state in FIG. 1, a partially-folded state in FIG. 3, and a folded state in FIG. 4. The folding of the product 10 will be described in greater detail below. Preferably, the product 10 is square or rectangular, but the product 10 can be made into nearly any conceivable shape.

The preferred substrate 12 is made of plastic or other polymeric material, preferably polypropylene, but may be made of other suitable materials. Additionally, the substrate 12 preferably has indicia 26 printed on either or both of the first and second surfaces 14,16. In one embodiment, the substrate 12 has map indicia printed thereon, and the product 10 is used as a map. Thus, the substrate preferably is suitable for printing.

The substrate layer 12 preferably has a thickness range between approximately 0.03 mm and 0.20 mm, however, it is understood by those of ordinary skill in the relevant art that other thicknesses and sizes of the plastic substrate 12 may be utilized without departing from the scope of the present invention. In a preferred embodiment the polypropylene film substrate 12 has a thickness between 0.10 mm and 0.20 mm thick and has a matte finish. The matte finish assists in providing protection against scuffing and abrasion of the plastic substrate 12, and it offers a good bonding surface. The plastic substrate 12 is generally chemical resistant and tear resistant, has very good tensile strength, and it is generally stable in moderate temperature ranges and changes in humidity. Further, the plastic substrate 12 is tougher, more durable, and more rigid than traditional paper substrates, and it retains its dimensions well following usage. Additionally, the plastic substrate 12, especially when provided as a polypropylene film, has good absorption properties which assist in providing good printability on the plastic substrate 12. Specifically, the polypropylene film plastic substrate 12 is well suited for screen-printing, letter press, lithography or flexography printing. And, it also works acceptably with thermal transfer, dot matrix printing, and information system usage. Further, one particular advantage of using a plastic substrate 12 is that a plastic substrate 12 is waterproof, making the entire hinged laminated plastic display 10 waterproof. Still further, the plastic substrate 12 is lighter than paper substrates and is recyclable even with the laminate layers 18, 20 connected thereto.

In one embodiment of the laminated plastic display 10, the plastic substrate 12 is a BCP grade of polypropylene film having the physical properties identified in Table I below:

TABLE 1

| Physical Property | BCP Grade Polypropylene Film Data |
|---|---|
| Thickness | 0.15 mm (range 0.08 mm to 0.20 mm) |
| Basic Weight | 206 g/m² |
| Specific Gravity | 1.375 |
| P.S.I. | 2,800 and up |
| Tensile Strength | 2,000 and up |
| Elongation | 40 and up |
| Tear Strength | 350 and up |
| Whiteness % | 86 |

Preferably, the substrate layer 12 includes a plurality of plastic panels 30 arranged in generally parallel and spaced relation, in a single row. Because the panels 30 are spaced, small gaps 32 preferably exist between adjacent panels 30. Preferably, these gaps 32 each have a width of between 0.09 in. and 0.250 in., however, it is understood by those of ordinary skill in the relevant art that gaps 32 of other widths may be utilized without departing from the scope of the present invention. In the preferred embodiment illustrated in FIGS. 1 and 2, the substrate layer 12 is comprised of four rectangular plastic panels 30A, 30B, 30C, 30D, each panel extending substantially across the width W of the product 10, and arranged in generally parallel and spaced relation, in a single row. It is understood that the number, shape and arrangement of the panels 30 may vary, and that the panels 30 may not extend completely across the width W of the product 10. In other embodiments, the substrate layer 12 may comprise more than one row of panels 30.

A first laminate layer or film 18 covers the first surface 14 of the substrate 12 and a second laminate layer or film 20 covers the second surface 16 of the substrate 12. Both laminate layers 18,20 are preferably made of a transparent plastic material, such as a polyester material, to allow the indicia 26 on the substrate 12 to be visible through the laminate layers. In a preferred embodiment, each laminate layer 18,20 is made of two laminate sheets, each covering a portion of the substrate 12. Preferably, the laminate layers 18,20 each have a thickness of between 0.5 mil and 3 mil, and preferably approximately 1.7 mil, however, it is understood by those of ordinary skill in the relevant art that laminate layers 18,20 of other thicknesses may be utilized without departing from the scope of the present invention. As illustrated in FIGS. 1, 2, and 6, the first laminate layer 18 includes a first laminate sheet 18a covering an upper portion 14a of the first surface 14 of the substrate layer 12 and a second laminate sheet 18b covering a lower portion 14b of the first surface 14 of the substrate layer 12. The first sheet 18a is preferably positioned in generally parallel and spaced relation to the second sheet 18b, and the space or gap 17 between the sheets 18a,18b defines an exposed portion 28 of the first surface 14 of the substrate layer 12. Similarly, the second laminate layer 20 includes a third laminate sheet 20a covering an upper portion 16a of the second surface 16 of the substrate layer 12 and a fourth laminate sheet 20b covering a lower portion 16b of the second surface 16 of the substrate layer 12. The third sheet 20a is preferably positioned in generally parallel and spaced relation to the fourth sheet 20b, and the space or gap 17 between the sheets 20a,20b defines an exposed portion 28 of the second surface 16 of the substrate layer 12. Preferably, the exposed portions 28 are located immediately opposite each other on the substrate 12.

The product 10 contains one or more linear hinges 22,24, allowing the product to fold. As illustrated in FIGS. 1, 2, and 6, in a preferred embodiment the product 10 has a single living hinge 22 extending the entire length L of the product 10, along a midline 23 of the product 10, and several lateral hinges 24, which are transverse to the living hinge 22, extending the entire width W of the product.

The living hinge 22 is preferably defined by the exposed portion 28 of the first surface 14 of the substrate layer 12 and the exposed portion 28 of the second surface 16 of the substrate layer 12. Thus, as illustrated in FIG. 6, the living hinge constitutes a line across the product 10 where only substrate material 12 is present, and laminate material 18,20 is absent. In other words, the substrate 12 is continuous across the living hinge 22. As stated above, the panels 30 of the substrate layer 12 preferably extend across the width W of the product 10, and the living hinge 22 extends across the length L of the product 10. Thus, the living hinge 22 preferably extends across all of the panels 30 of the substrate layer 12. Alternate embodiments may contain a greater number of living hinges 22, and may also contain one or more additional hinges extending across the length of the product 10. Further, in alternate embodiments the living hinge 22 may be comprised of a region where the laminate material 18, 20 is thinner, or at a region where the laminate material is not present on only one surface of the substrate 12.

In one embodiment the lateral hinges 24 preferably extend across the width W of the product 10, parallel to the panels 30. Each lateral hinge 24 is preferably defined by the gaps 32 between adjacent panels 30. Thus, each lateral hinge 24 preferably constitutes a line across the product 10 where only laminate material 18,20 is present, and substrate material 12 is absent. Additionally, because the lateral hinges 24 preferably exist between the panels 30, the number of lateral hinges 24 is preferably one fewer than the number of panels 30 in the product 10. It is understood that increasing or decreasing the number of panels 30 in the product can correspondingly increase or decrease the number of lateral hinges 24. Alternate embodiments may contain a greater or smaller number of lateral hinges 24, and further some lateral hinges may be similar to the living hinge 22 described above. Additionally, some of the hinges 22,24 in the product may extend across both the substrate 12 and the laminate layers 18,20.

The hinges 22,24 are preferably designed to be of an acceptable width to allow the panels 30 to be able to fold substantially flat on themselves. In a preferred folded embodiment, as shown in FIG. 4, the width (A) of the lateral hinges 24 between the panels 30 should generally be greater than the sum of twice the thickness of the plastic substrate panels 30. Further, if the product 10 has a single, central living hinge 22, the width (B) of the living hinge 22 should generally be greater than the width (A) of the lateral hinges 24, and preferably should be greater than the sum of the thickness of all the panels 30 of the product 10. It is understood that in a preferred embodiment each hinge 22,24 should generally have a width (A,B) that is greater than the total of the thicknesses of all of the panels 30 folding along that hinge 22,24.

The preferred assembly of the product 10 is illustrated in FIG. 2. The panels 30 of the substrate layer 12 are arranged in parallel and spaced relation, in a row. Then, the first and second laminate layers 18,20 are applied to the surfaces 14,16 of the substrate layer 12. Specifically, the first laminate sheet 18a is applied to the upper portion 14a of the first surface 14 of the substrate 12, the second laminate sheet 18b is applied to the lower portion 14b of the first surface 14 of the substrate 12, the third laminate sheet 20a is applied to the upper portion 16a of the second surface 16 of the substrate 12, and the fourth laminate sheet 20b is applied to the lower portion 16b of the second surface 16 of the substrate 12. After the laminate layers 18,20 have been applied to the substrate 12, the laminate layers 18,20 may be sealed around the periphery of the product 10 and also along the lateral hinges 24, in the gaps 32 between the panels 30. Further, depending on the combinations of materials utilized, the laminate layers 18,20 may also seal to the substrate layer 12 itself, thereby creating a unitary product, and one which does not necessarily need a laminate seal around the periphery of the product 10.

Because the panels 12 of the hinged laminated plastic product 10 are made of a plastic substrate, the laminating material 14 need not extend beyond the perimeter of any of the panels 12 in order to provide a waterproof display 10. For example, if the panels were made of paperboard, to provide a waterproof product the laminating material may have an external skirt extending the entire perimeter of the product. This increases the size and cost of the product. Further, should the laminated perimeter of such a product not have an adequate seal, the waterproof integrity of the product may be compromised. In the present embodiment with plastic substrate panels 12, however, the laminating product 14 may be terminated at the periphery of the panels 12 without compromising the waterproof integrity of the hinged laminated plastic product 10. If the laminate layers 18,20 overlap the edges of the substrate, the first laminate layer 18 and the second laminate layer 20 may be sealed to each other to hold the substrate 12 therebetween. It is understood, however, that in an alternate embodiment, the laminate layers 18,20 may be sealed together around the periphery of the product 10, as well as along the lateral hinges 24 in the gaps 32 separating the panels 14 of the substrate layer 12. In this embodiment, the first laminate sheet 18a is sealed to the third laminate sheet 20a, and the second laminate sheet 18b is sealed to the fourth laminate sheet 20b.

The folding of the product 10 is illustrated in FIGS. 3 and 4. Preferably, the product 10 is folded accordion-style along the lateral hinges 24, as illustrated in FIG. 4, forming a partially-folded product 10 that is approximately the length and width of a single panel 30. Then, the partially-folded product 10 is folded along the central living hinge 22 to form a completely folded product 10, as illustrated in FIG. 3. It is understood that a different arrangement of panels 30 and hinges 22,24 may make a different folding method advantageous or necessary.

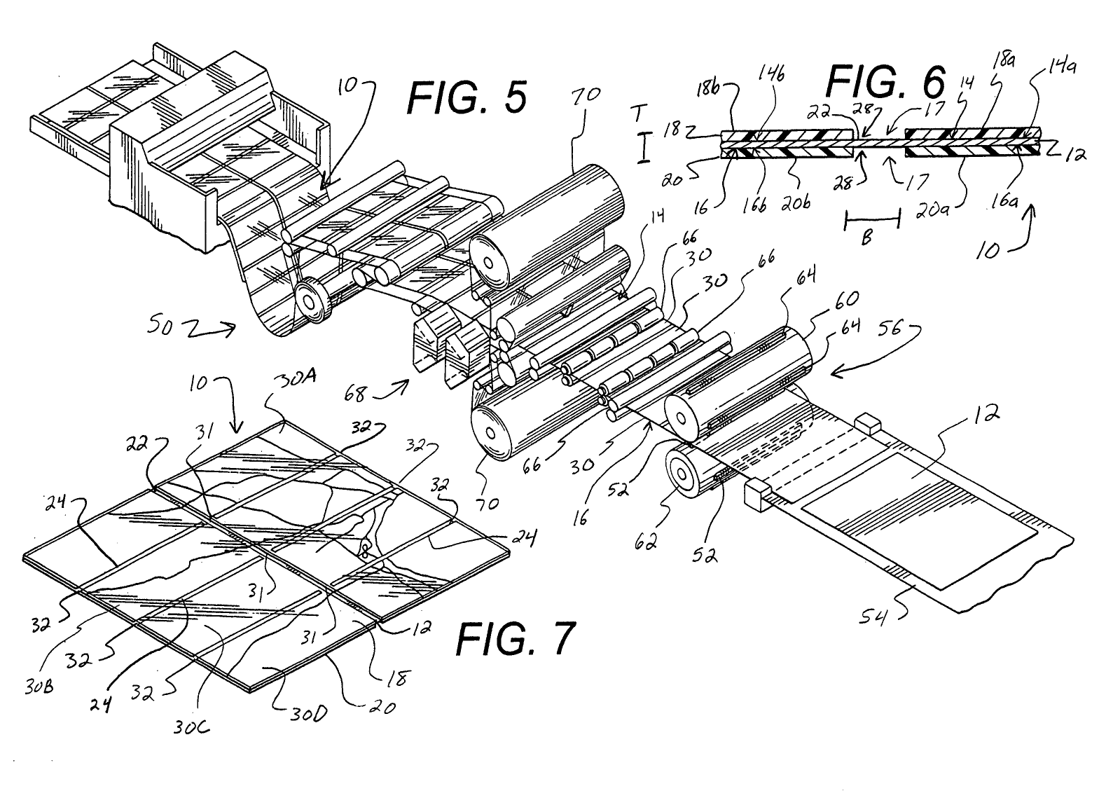

The assembly or manufacturing of the product 10 may be done by a suitable processing machine 50, as illustrated in FIG. 5. Typically, the hinged laminated product 10 will be manufactured from a larger plastic substrate 12 that is cut or sheared into panels 30. Indicia 26 is preferably printed on the substrate 12 before cutting. Thus, the indicia 26 is preferably printed in an arrangement that anticipates that material will be cut from the substrate 12, ensuring that no information will be lost during the manufacturing process. The hinged laminated product 10 may be manufactured on an in-line process, on an L-shaped conveyer, or with some other manufacturing process, including the manufacturing of individual products separately. In a preferred embodiment, shown schematically in FIG. 5, a feeder (not shown) is utilized to feed the large plastic substrate 12 onto a registration table 54. The registration table 54 typically includes a series of rollers, often driven rollers, to maintain the substrate 12 in motion as desired. Additionally, the substrate 12 is registered in a proper position at the registration table 54, to provide for consistent cutting of the substrate 12 and consistent panel size. The large plastic substrate 12 is fed from the registration table 54 to a die-cutter assembly 56 to convert the substrate 12 into the individual panels 30.

In a preferred embodiment, the die-cutter assembly 56 contains an in-line rotary die-cutter which is able to die-cut the gaps at the appropriate spacing between the adjacent panels 30. The preferred cutter 56 includes two cylindrical rotary cutting heads 60,62. The first cutting head 60 typically has a series of cutting knives 64 spaced around the circumference, and the second cutting head 62 typically has a series of anvils 52 spaced around the circumference to engage the cutting knives 64. Alternately, the second cutting head 62 has a consistent anvil-type surface. The substrate 12 is fed into the cutter 56 between the cutting heads 60,62, while the cutting heads 60,62 rotate at a controlled speed As the cutting heads 60,62 rotate, the spaced knives 64 contact the anvils 52 on the second cutting head 62 at regular intervals. Each time a knife 64 contacts an anvil 52 on the second cutting head 62, the substrate 12 is cut. The size of the panels 30 cut by the cutter 56 can be controlled by changing the spacing of the cutting knives 64 or the speed of rotation of the cutting heads 60,62. In a preferred embodiment, the cutting heads 60,62 operate on servo motors to control the cutting speed and adjust cutting width. Thus, the cutter 56 can create panels 30 of any desired width. Additionally, the rotary cutter 56 can be configured to cut different shapes of panels 30. This ability to cut panels 30 of different sizes and shapes provides an advantage over prior technology that utilizes circular slitters. Further, in a preferred embodiment, the cutter assembly 56 is automatically registerable for creating the die cuts and is able to remove the cut-away material from the plastic sheets.

A series of driven nip rollers 66 is provided immediately downstream of the die cutter 56. The panels 30 are fed from the die cutter 56 and into the nip rollers 66. The nip rollers 66 maintain the appropriate spacing and registration for the panels 30 to allow for appropriate spacing for the creation of the hinges 24 between the panels 30 prior to entering the laminator 68. In another embodiment, a vacuum conveyer (not shown) may replace the nip rollers. A vacuum conveyor can provide for maintaining appropriate registration for unlimited sizes of panels to be created and laminated without the need to alter the manufacturing process or manufacturing machinery.

The nip rollers 66 feed the panels 30 into the laminator 68. As illustrated in FIG. 5, in a preferred embodiment the laminator 68 is a high-speed double-sided laminator having two laminate feed rolls 70. One of the laminate feed rolls 70 feeds laminate material onto the first surface 14 of the substrate 12, creating the first laminate layer 18, and the other laminate feed roll 70 feeds laminate material onto the second surface 16 of the substrate 12, creating the second laminate layer 20. The laminate material feeding from each of the rolls 70 is preferably split or slit at the center, creating the exposed portions 28 of the first and second substrate surfaces 14,16 when the laminate material 18,20 is deposited onto the substrate 12. In an alternate embodiment, the laminate material may be fed from four smaller rolls, rather than splitting the laminate material from two larger rolls 70. The laminate material may require heating before depositing on the substrate, which is preferably done by running the material over heat rolls (not shown) between the feed rolls 70 and the substrate.

Preferably, the laminator 68 is able to laminate the plastic substrate panels 30 with any size, thickness or make (i.e., thermal or pressure sensitive) of lamination product 18,20. In the manufacturing process shown in FIG. 5, after the panels 30 are laminated with the lamination product 18,20, adjacent products 10 are connected together in a web form. When a thermal lamination product is utilized, the web is typically channeled through a series of cooling rollers (not shown) to cool the lamination product 18,20. In one embodiment, the laminator 68 also contains backup laminate rolls that are connected to the primary laminate feed rolls 70 so that when one of the feed rolls 70 is empty, the backup roll will automatically continue the laminate feed, ensuring a continuous feed of laminate material.

A second cutter or slitter 71 is typically located downstream of the laminator 68. The second cutter 71 is preferably configured to trim the edges of the product and remove the waste and scrap that is cut. Further, another cutter (not shown), such as an in-line rotary die cutter, may be provided downstream to separate the products 10 from their prior web format. Alternatively, shears or other cutting mechanisms may be utilized without departing from the scope of the present invention. After the final cutting the laminated plastic product 10 is transferred, typically on another conveyer, and fed into an automatic folding apparatus (not shown) to fold the laminated plastic product 10 in its hinged format.

It is understood that changes to the configuration and arrangement of the panels 30 and hinges 22,24 may necessitate changes to the manufacturing operation, including the cutting and laminating operations.

An alternate embodiment of the product 10 is shown in FIG. 7. All features of the alternate embodiment of the product 10 are similar to those described above, except that the panels of the embodiment shown in FIG. 7 are not completely separated. Instead, all of the panels 30A, 30B, 30C, 30D of the embodiment in FIG. 7 are connected along the central living hinge 22. As shown in FIG. 7, connecting portions 31 connect the panels 30 together near the living hinge 22. The gaps 32 between the panels extend from the connecting portions 31 to the edges of the product 10. Thus, as shown in FIG. 7, each of the lateral hinges 24 extends across a portion of the substrate layer 12 near the living hinge 22. This embodiment of the product 10 is manufactured similar to the first embodiment described. One difference, however, may be that the cutting heads 60,62 may be adjusted so as not to cut completely across the substrate 12, which can be accomplished by creating a space in the center of each cutting knife 64.

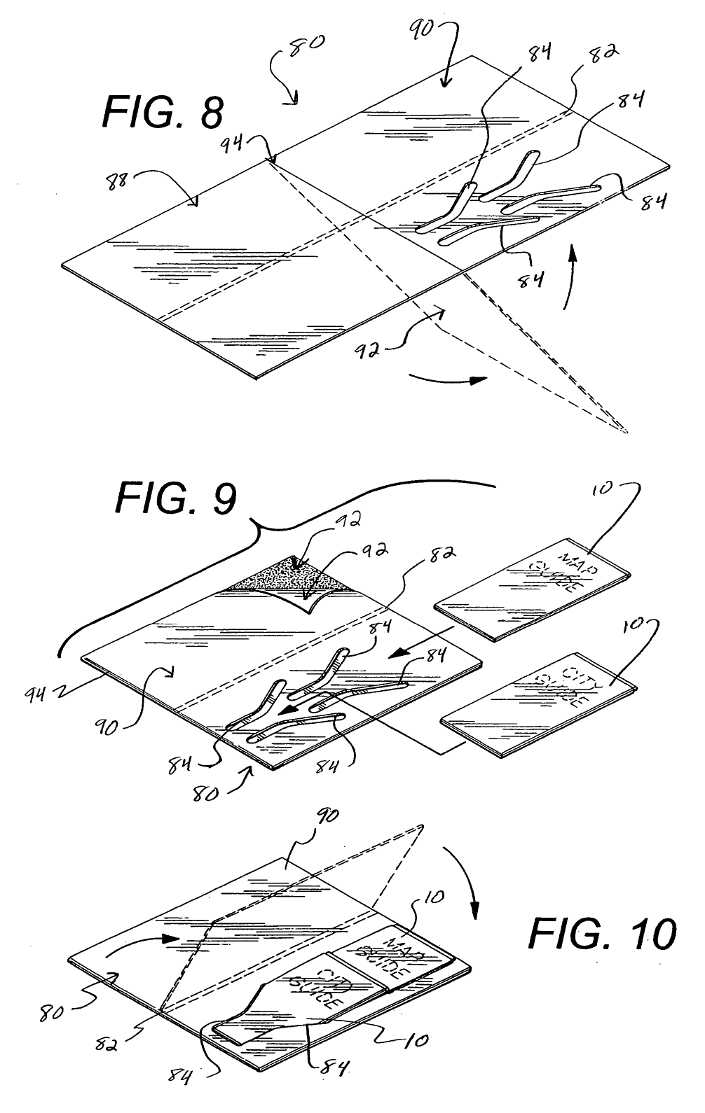

A retaining folder 80, shown in FIGS. 8-10, may be used with the product 10 of the present invention, or with other product. The folder 80 is preferably made of the same substrate material as the product 10, however, alternate material may be utilized without departing from the scope of the present invention. For example, the folder 80 may be made of a paper or paper-based material. Additionally, the folder 80 may have a first layer of laminating film (not shown) placed on or connected to the first surface 90 of the substrate of the folder 80, and a second laminate layer or film (not shown) placed on or connected to the second surface 92 of the substrate of the folder 80. Both laminate layers are preferably made of a transparent polymeric material to allow any indicia the folder substrate to be visible. In one embodiment, the overlaminate material for the folder 80 is made of a 1.2 mil polyester material.

In the assembled state, shown in FIG. 10, the folder 80 has a single hinge 82 and several apertures or pockets 84 into which one or more products 10 of the present invention, or similar articles, can be inserted. The assembled folder 80 can be folded along the hinge 82 to close the folder 80, as shown in FIG. 10. Additionally, the folder 80 may have indicia printed on the outer surface thereof.

The preferred assembly of the folder, illustrated in FIGS. 8 and 9, is quick and simple. A single sheet 88 of substrate material (with or without an outer laminating film), having opposed first and second sides 90,92, is cut into a desired shape and indicia is printed on the first surface 90. In one embodiment the apertures 84 are cut into one quarter of the sheet 88, preferably prior to further assembly, however, in alternate embodiments one or more apertures 84 may be provided in one quarter of the sheet and one or more apertures 84 may be provided in a different quarter of the sheet. In such an alternate embodiment the apertures 84 are on opposing sides of the folder 80 following final construction. After the apertures 84 are provided in the sheet, the sheet is then folded over along a fold line 94 so that portions of the second surface 92 contact each other, forming the assembled folder 80. Thus, the entire outside of the folder 80 is comprised of the first surface 92 of the sheet 88, and the second surface 94 is located on the inside of the folder 80. After folding, at least a portion of the second surface 92 of the folder is sealed together, typically at least an outer perimeter of the second surface, either by heat sealing, applying adhesive or similar substance to the second surface 92, or other known method of sealing to create a pocket between adjacent second surfaces 92. When assembled, articles inserted into the apertures 84 and portions of the articles are maintained in the pocket of the folder 80. As illustrated in FIGS. 9-10, folded hinged laminated products 10 of the present invention can be inserted into the apertures 84 and held by the folder 80.

The folder 80 can be made into any desired shape simply by cutting the sheet 88 appropriately. Typically, the sheet 88 will be cut in a symmetrical manner to ensure that the folder 80 is symmetrical. Additionally, the sheet 88 used in making the folder 80 can be cut to size by a rotary cutting head in the same manner as the substrate 12 used in manufacturing the product. Further, the slots 84 can be cut in a different number, size or arrangement as desired.

In alternate embodiments, the folder 80 may also be laminated similarly to the product 10, either before or after assembly. Additionally, the folder 80 may be manufactured out of two panels, similar to the panels 30 of the product 10. Further, if the folder 80 is laminated, the hinges 82 of the folder 80 may be defined by exposed portion of the folder substrate, like the living hinge 22 described above, or may be defined by a gap between adjacent panels, like the lateral hinges 24 described above.

Various uses of for the hinged laminated plastic product 10 include, but are not limited to maps, reference guides, marketing brochures, mailers, product information guides, military training guides, programming guides, educational/academic guides, game boards etc. Additionally, the hinged laminated plastic product 10 may be utilized as a pocket folder, compact disc sleeve, promotional item, or any other item that utilizes a crease or score.

Hinged laminated products, such as the product 10 disclosed herein, often have only one hinge extending lengthwise across the product, and such hinges often have significant width to accommodate the thickness of the folded product 10. In prior designs, where the substrate was not continuous across the hinge, this resulted in a large gap between indicia contained on opposite sides of the hinge. However, because the substrate 12 is continuous across the living hinge 22, the product 10 allows for indicia to be read across the living hinge 22 when the product 10 is unfolded.

Additionally, as described above, the use of a plastic substrate confers many advantages over prior products having paperboard substrates. The plastic substrate 12 is waterproof, strong, tough, durable, rigid, and resistant to chemicals, heat, humidity, abrasion, and tearing. The plastic substrate 12 is comparatively light weight and also offers good dimensional stability, printability, and recyclability.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” “fourth,” “upper,” “lower,” “length,” “width,” etc., as used herein, are intended for illustrative purposes only and do not limit the embodiments in any way. Still further, the term “plurality,” as used herein, indicates any number greater than one, either disjunctively or conjunctively, as necessary, up to an infinite number.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying claims.

What is claimed is:

1. A laminated folding product comprising:
a plastic substrate layer having indicia printed thereon and having first and second opposed surfaces;
a first transparent laminate layer covering the first surface of the substrate layer;
a second transparent laminate layer covering the second surface of the substrate layer; and
a first linear hinge extending across the product.

2. The laminated folding product of claim 1, wherein a portion of the first surface of the substrate layer surrounding the first linear hinge and a portion of the second surface of the substrate layer surrounding the first linear hinge are exposed.

3. The laminated folding product of claim 1, further comprising a second linear hinge extending across the product transverse to the first linear hinge, wherein the product folds along the first linear hinge and the second linear hinge.

4. The laminated folding product of claim 3, further comprising a second linear hinge extending across the product, the second linear hinge comprising a portion of the first laminate layer, a portion of the second laminate layer, and an absence of the substrate layer.

5. The laminated folding product of claim 1, wherein the plastic substrate layer is made of polypropylene film.

6. A hinged laminated product having a width and a length, the product comprising:
a first rectangular panel having a top surface and a bottom surface, the first panel having indicia printed thereon and extending substantially across the width of the laminated product;
a second rectangular panel having a top surface and a bottom surface, the second panel having indicia printed thereon and extending substantially across the width of the laminated product, wherein the second panel is positioned in generally parallel and spaced relation to the first panel;
a first transparent laminate sheet covering at least a portion of the top surface of the first panel and at least a portion of the top surface of the second panel;
a second transparent laminate sheet covering at least a portion of the bottom surface of the first panel and at least a portion of the bottom surface of the second panel; and
a first linear hinge extending across the product.

7. The hinged laminated product of claim 6, wherein the length of the product is greater than the width of the product.

8. The hinged laminated product of claim 6, wherein the first linear hinge is located between the first panel and the second panel and extends across the width of the product.

9. The hinged laminated product of claim 6, wherein the first linear hinge crosses the first panel and the second panel and extends across the length of the product.

10. The hinged laminated product of claim 6, wherein the first laminate sheet and the second laminate sheet extend substantially across the length of the product.

11. The hinged laminated product of claim 6, further comprising a second linear hinge, wherein the first linear hinge is located between the first panel and the second panel and extends across the width of the product and the second linear hinge crosses the first panel and the second panel and extends across the length of the product, and wherein the product folds along the first linear hinge and the second linear hinge.

12. The hinged laminated product of claim 6, further comprising:
a third transparent laminate sheet covering at least a portion of the top surface of the first panel and at least a portion of the top surface of the second panel, wherein the third laminate sheet is positioned in generally parallel and spaced relation to the first laminate sheet; and
a fourth transparent laminate sheet covering at least a portion of the bottom surface of the first panel and at least a portion of the bottom surface of the second panel, wherein the fourth laminate sheet is positioned in generally parallel and spaced relation to the second laminate sheet.

13. A hinged laminated product comprising:
a substrate layer having indicia printed thereon and having first and second opposed surfaces;
a first transparent laminate layer covering the first surface of the substrate layer, the first laminate layer having a gap, leaving a portion of the first surface of the substrate layer exposed; and
a second transparent laminate layer covering a portion of the second surface of the substrate layer, the second laminate layer having a gap, leaving a portion of the second surface of the substrate layer exposed,
wherein the exposed portion of the first surface of the substrate layer and the exposed portion of the second surface of the substrate layer define a living hinge, wherein the product folds along the living hinge.

14. The hinged laminated product of claim 13, wherein the substrate layer comprises a plurality of panels arranged in a row and extending substantially across a width of the product.

15. The hinged laminated product of claim 13, further comprising a plurality of lateral hinges extending transversely to the living hinge, and wherein each of the lateral hinges comprises a gap in the substrate layer.

16. The hinged laminated product of claim 15, wherein the first laminate layer is sealed to the second laminate layer along each of the plurality of lateral hinges.

17. The hinged laminated product of claim 13, wherein the first laminate layer is sealed to the second laminate layer around a periphery of the product.

18. The hinged laminated product of claim 13, wherein the living hinge bisects the product generally about a midline of the product.

19. A laminated folding product having a length and a width, comprising:
a plastic substrate layer having indicia printed thereon and comprising a plurality of panels arranged in generally parallel and spaced relation in a single row, each panel extending substantially across the width of the product;
a first transparent plastic laminate layer on a first surface of the substrate layer, comprising a first laminate sheet covering an upper portion of the first surface of the substrate layer and a second laminate sheet covering a lower portion of the first surface of the substrate layer, the first sheet spaced from the second sheet to define an exposed portion of the first surface of the substrate layer;
a second transparent plastic laminate layer on a second surface of the substrate layer, comprising a third laminate sheet covering an upper portion of the second surface of the substrate layer and a fourth laminate sheet covering a lower portion of the second surface of the substrate layer, the third sheet spaced from the fourth sheet to define an exposed portion of the second surface of the substrate layer;
a plurality of lateral hinges extending across the width of the product, each of the lateral hinges located between adjacent panels; and
a living hinge extending lengthwise across the product, the living hinge defined by the exposed portion of the first surface of the substrate layer and the exposed portion of the second surface of the substrate layer.

20. The laminated folding product of claim 19, wherein the product folds accordion-style at the lateral hinges and then folds along the living hinge.
